(19) United States
(12) Patent Application Publication
(10) Pub. No.: US 2025/0183400 A1
(43) Pub. Date: Jun. 5, 2025

(54) FIREPROOFED MULTILAYER TUBULAR STRUCTURE FOR COOLING ELECTRIC VEHICLE BATTERIES OR STATIONARY ENERGY STORAGE SYSTEM BATTERIES

(71) Applicant: ARKEMA FRANCE, COLOMBES (FR)

(72) Inventors: Marjorie MARCOURT, Serquigny (FR); Florent ABGRALL, Serquigny (FR); Antoine GOUPIL, Seoul (KR)

(73) Assignee: ARKEMA FRANCE, COLOMBES (FR)

(21) Appl. No.: 18/845,101

(22) PCT Filed: Mar. 8, 2023
(86) PCT No.: PCT/FR2023/050313

§ 371 Date: Sep. 9, 2024

(30) Foreign Application Priority Data
Mar. 10, 2022 (FR) FR2202084

(51) Int. Cl. H01M 10/613; H01M 10/625; H01M 10/627

(52) U.S. Cl. CPC H01M 10/613; H01M 10/625; H01M 10/627

(57) ABSTRACT

The present invention relates to a flame-retardant multilayer tubular structure for the cooling of electric vehicle batteries or of stationary energy storage system batteries, comprising at least two layers: an inner layer (I) comprising at least 40% of at least one thermoplastic polymer P1 chosen from a polyolefin and a thermoplastic elastomer and up to 5% by weight of a compound chosen from a heat stabilizer and a metal deactivator or a mixture of these, an outer layer (II) comprising a composition based on at least one predominant polyamide, said composition comprising, by weight: a) at least 50% of at least one polyamide, b) from 15% to 38% of at least one flame retardant, c) from 4% to 20%, in particular 4% to 15%, of a polyolefin, d) from 0% to 10%, in particular from 0.1% to 10%, by weight of at least one plasticizer, e) from 0% to 5%, in particular from 0.1% to 5%, of at least one additive, the sum a)+b)+c)+d)+e) being equal to 100%.

The present invention relates to a flame-retardant multilayer tubular structure for the cooling of batteries of electric vehicles or of stationary energy storage systems.

One of the desired aims, in particular in the motor vehicle field, is to propose vehicles which are less and less polluting. Thus, electric or hybrid vehicles comprising a battery are targeted at gradually replacing thermal vehicles, such as gasoline or else diesel vehicles.

In point of fact, it turns out that the battery is a relatively complex constituent of the vehicle. Depending on the location of the battery in the vehicle, it may be necessary to protect it from impacts and from the external environment, which can be at extreme temperatures and at a variable humidity. It is also necessary to avoid any risk of flames.

In addition, it is important for its operating temperature not to exceed 55° C. in order not to damage the cells of the battery and to preserve its service life. Conversely, for example in winter, it may be necessary to raise the temperature of the battery so as to optimize its operation.

Another aim desired, in particular in stationary energy storage systems, is to have available systems which make it possible to smooth out the production of renewable energies, to operate electric vehicles or very simply to strengthen electrical networks.

Thus, stationary storage becomes strategic because it helps to ensure the balance between electricity production and consumption. Energy is stored during off-peak or high production periods, and is subsequently released later in the event of high demand or of lower production.

The electric or hybrid motor vehicle or stationary energy storage systems thus require a device for cooling the battery or the system which generally consists of multilayer tubular lines.

In order to protect the integrity of the vehicle or of the system, the lines must provide fire resistance. These lines fall into two categories, in particular for electric vehicles: lines inside the battery pack and lines outside the battery pack. The specifications for the lines outside the battery pack are more stringent and also require resistance to zinc chloride (environment under the hood) and resistance to cold shock.

These battery cooling lines or stationary energy storage system cooling lines generally transport a coolant and long-chain polyamides are well suited for said lines. They exhibit a good service life in contact with the coolant (90-110° C.) while providing:
flexibility of the structures, which facilitates fitting to the vehicles,
resistance of the structures in a harsh environment under the hood.

It is also possible to confer fire resistance on the polyamides by the addition of flame-retardant fillers which uses the compounding route. However, this fireproofing technique no longer makes it possible to provide the main properties required for the battery or stationary energy storage system cooling application because such a polyamide is brittle and the tubular line thus formed would thus have an insufficient impact strength.

This aim is achieved by the development of multilayer solutions which thus make it possible to combine all the abovementioned properties and to meet the complex specifications of the application.

Thus, the present invention relates to a flame-retardant multilayer tubular structure for the cooling of electric vehicle batteries or of stationary energy storage system batteries comprising at least two layers:
an inner layer (I) comprising, with respect to the total weight of the layer (I), at least 40% by weight of at least one thermoplastic polymer P1 chosen from a polyolefin, a thermoplastic elastomer and a blend of these, and up to 5% by weight of a compound chosen from a heat stabilizer and a metal deactivator or a mixture of these,
an outer layer (II) comprising a composition based on at least one predominant polyamide, said composition comprising, by weight, with respect to the total weight of the layer (II):
a) at least 50% of at least one polyamide,
b) from 15% to 38% of at least one flame retardant,
c) from 4% to 20%, in particular from 4% to 15%, of a polyolefin,
d) from 0% to 10%, in particular from 0.1% to 10%, by weight, of at least one plasticizer,
e) from 0% to 5%, in particular from 0.1% to 5%, of at least one additive, the sum a)+b)+c)+d)+e) being equal to 100%.

The present invention thus relates to a flame-retardant multilayer tubular structure for the cooling of electric vehicle batteries or of stationary energy storage system batteries comprising at least two layers:
an inner layer (I) comprising, with respect to the total weight of the layer (I), at least 40% by weight of at least one thermoplastic polymer P1 chosen from a polyolefin, a thermoplastic elastomer and a blend of these,
an outer layer (II) comprising a composition based on at least one predominant polyamide, said composition comprising, by weight, with respect to the total weight of the layer (II):
a) at least 50% of at least one polyamide,
b) from 15% to 38% of at least one flame retardant,
c) from 4% to 20%, in particular from 4% to 15%, of a polyolefin,
d) from 0% to 10%, in particular from 0.1% to 10%, by weight, of at least one plasticizer,
e) from 0% to 5%, in particular from 0.1% to 5%, of at least one additive, the sum a)+b)+c)+d)+e) being equal to 100%.

According to one embodiment, the present invention relates to a flame-retardant multilayer tubular structure for the cooling of electric vehicle batteries or of stationary energy storage system batteries comprising at least two layers:
an inner layer (I) comprising, with respect to the total weight of the layer (I), at least 20% by weight of a polyolefin, optionally from 0% to 80% by weight of an elastomer and optionally from 0% to 5% by weight of a heat stabilizer,
an outer layer (II) comprising a composition based on at least one predominant polyamide, said composition comprising, by weight, with respect to the total weight of the layer (II):
a) at least 50% by weight of at least one polyamide,
b) from 15% to 38% by weight of at least one flame retardant,
c) from 4% to 20% by weight, in particular from 4% to 15% by weight, of a polyolefin,
d) from 0% to 10% by weight, in particular from 0.1% to 10% by weight, of at least one plasticizer,
e) from 0% to 5% by weight, in particular from 0.1% to 5% by weight, of at least one additive,
the sum a)+b)+c)+d)+e) being equal to 100%. The inventors have thus found, unexpectedly, that a multilayer structure comprising at least two layers, the inner layer of which consists of optionally stabilized polyolefin and the outer layer of which is based on polyamide comprising a flame retardant, made it possible to form a structure combining fire resistance and a good service life in prolonged contact with a coolant, flexibility, resistance to zinc chloride and good bursting strength, characteristics essential for the application of cooling electric vehicle batteries or stationary energy storage system batteries.

In one embodiment, said inner layer (I) comprises, with respect to the total weight of said layer (I), at least 40% by weight, in particular at least 50% by weight, especially at least 60% by weight, of at least one thermoplastic polymer P1 chosen from a polyolefin, a thermoplastic elastomer and a blend of these, and up to 5% by weight of a compound chosen from a heat stabilizer and a metal deactivator or a mixture of these.

In one embodiment, said inner layer (I) comprises, with respect to the total weight of said layer (I), at least 40% by weight, in particular at least 50% by weight, especially at least 60% by weight, of at least one polyolefin.

In one embodiment, said inner layer (I) comprises, with respect to the total weight of said layer (I), up to 5% by weight of a heat stabilizer, that is to say from 0% by weight (inclusive) to 5% by weight (inclusive), of a heat stabilizer.

The expression “multilayer tubular structure” should be understood as meaning a tube structure or pipe structure of cylindrical shape and of circular section.

The term “battery” should be understood as meaning a set of electrical accumulators, also called a “battery pack”.

The term “vehicle” should be understood as meaning a car, a truck, a train or an airplane, in particular a car.

The expression “stationary energy storage system” should be understood as meaning, for example, the storage of electricity produced by renewable energies, the improvement in the stability of electricity networks or also the support of own use of electricity by individuals or businesses, this being done by means of mechanical storage, for example a pumping station, compressed air or inertia storage, of chemical storage or of electrochemical storage.

The term “flame-retardant” means that the tubular structure is fire resistant with a V0 result in the UL94 test at 0.8 mm (IEC 60695-11-10).

The UL94 test, generally applied to a bar of a single product, is carried out here on a monolayer structure (monolayer tube) or multilayer structure, in particular a three-layer tube, with the flame which is brought into contact solely with the outer layer of the tube, said three-layer tube exhibiting the following layer dimensions: from the outer layer to the inner layer: 0.15 mm//0.10 mm//0.75 mm or 0.350 mm//0.10 mm//0.55 mm.

### Regarding the Polyamide

The nomenclature used to define the polyamides is described in the standard ISO 1874-1:2011,
“Plastics—Polyamide (PA) molding and extrusion materials—Part 1: Designation”, in particular on page 3 (tables 1 and 2), and is well known to a person skilled in the art.

According to the present patent application, the term “polyamide”, also denoted “PA”, is targeted at:
homopolymers,
copolymers, or copolyamides, based on different amide units, such as, for example, copolyamide 6/12 with amide units derived from lactam-6 and from lactam-12,
polyamide alloys, provided that the polyamide is the predominant constituent.

There also exists a category of copolyamides within the broad sense which, although not preferred, come within the scope of the invention. They are copolyamides comprising not only amide units (which will be predominant, hence the fact that they are to be considered as copolyamides within the broad sense) but also units of nonamide nature, for example ether units. The most well-known examples are PEBAs or polyether-block-amides, and their copolyamide-ester-ether, copolyamide-ether or copolyamide-ester variants. Mention may be made, among these, of PEBA-12, where the polyamide units are the same as those of PA12, and PEBA-6.12, where the polyamide units are the same as those of PA6.12.

Said polyamide can be an amorphous or semicrystalline polyamide.

An amorphous polyamide, within the meaning of the invention, denotes a polyamide which exhibits only a glass transition temperature (no melting point (Tm)) or a very slightly crystalline polyamide having a glass transition temperature and a melting point such that the enthalpy of crystallization during the stage of cooling at a rate of 20 K/min, measured according to the standard ISO 11357-3:2013, is less than 30 J/g, in particular less than 20 J/g, preferably less than 15 J/g.

A semicrystalline polyamide, within the meaning of the invention, denotes a polyamide which exhibits a glass transition temperature, determined by dynamic mechanical analysis (DMA) according to the standard ISO 6721-11:2019, and a melting point (Tm), determined according to the standard ISO 11357-3:2013, and an enthalpy of crystallization during the stage of cooling at a rate of 20 K/min in DSC, measured according to the standard ISO 11357-3 of 2013, of greater than 30 J/g, preferably of greater than 35 J/g.

In a first alternative form, said polyamide can be obtained from the polycondensation of at least one aminocarboxylic acid comprising from 6 to 18 carbon atoms, preferentially from 9 to 18 carbon atoms, more preferentially from 10 to 18 carbon atoms, more preferentially still from 10 to 12 carbon atoms. It can thus be chosen from 6-aminohexanoic acid, 7-aminoheptanoic acid, 8-aminooctanoic acid, 9-aminononanoic acid, 10-aminodecanoic acid, 11-aminoundecanoic acid, 12-aminododecanoic acid, 13-aminotridecanoic acid, 14-aminotetradecanoic acid, 15-aminopentadecanoic acid, 16-aminohexadecanoic acid, 17-aminoheptadecanoic acid or 18-aminooctadecanoic acid.

Preferentially, it is obtained from the polycondensation of a single aminocarboxylic acid.

In a second alternative form, said polyamide can be obtained from the polycondensation of at least one lactam comprising from 6 to 18 carbon atoms, preferentially from 9 to 18 carbon atoms, more preferentially from 10 to 18 carbon atoms, more preferentially still from 10 to 12 carbon atoms.

Preferentially, it is obtained from the polycondensation of a single lactam.

In a third alternative form, said polyamide can be obtained from the polycondensation of at least one diamine X which can be aliphatic, cycloaliphatic or aromatic, in particular aliphatic, comprising from 4 to 36 carbon atoms, advantageously from 6 to 18 carbon atoms, advantageously from 6 to 12 carbon atoms, advantageously from 10 to 12 carbon atoms, and of at least one dicarboxylic acid Y which can be aliphatic, cycloaliphatic or aromatic, in particular aliphatic, comprising from 4 to 36 carbon atoms, advantageously from 6 to 18 carbon atoms, advantageously from 6 to 12 carbon atoms, advantageously from 10 to 12 carbon atoms, to form a repeat unit XY.

The aliphatic diamine used is an aliphatic diamine which exhibits a linear main chain comprising at least 4 carbon atoms.

This linear main chain can, if appropriate, comprise one or more methyl and/or ethyl substituents; in this latter configuration, the term “branched aliphatic diamine” is used. In the case where the main chain does not comprise any substituent, the aliphatic diamine is referred to as “linear aliphatic diamine”.

Whether or not it comprises methyl and/or ethyl substituents on the main chain, the aliphatic diamine used to obtain this repeat unit X.Y comprises from 4 to 36 carbon atoms, advantageously from 4 to 18 carbon atoms, advantageously from 6 to 18 carbon atoms, advantageously from 6 to 14 carbon atoms.

When this diamine is a linear aliphatic diamine, it then corresponds to the formula H₂N—(CH₂)ₓ—NH₂ and can be chosen, for example, from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines which have just been mentioned can be all biobased within the meaning of the standard ASTM D6866.

When this diamine is a branched aliphatic diamine, it can in particular be 2-methylpentanediamine, 2-methyl-1,8-octanediamine or (2,2,4-or 2,4,4-)trimethylhexanediamine.

The cycloaliphatic diamine used can be chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane or 3,3′-dimethyl-4,4′-diaminodicyclohexylmethane, commonly known as BMACM or MACM (and denoted B hereinbelow) bis(p-aminocyclohexyl)methane, commonly known as PACM (and denoted P hereinbelow), in particular Dicykan®, isopropylidenedi(cyclohexylamine), commonly known as PACP, isophoronediamine (denoted IPD hereinbelow), and 2,6-bis(aminomethyl)norbornane, commonly known as BAMN, and bis(aminomethyl)cyclohexane (BAC), in particular 1,3-BAC or, in particular 1,4-BAC.

Advantageously, it is chosen from bis(3-methyl-4-aminocyclohexyl)methane or 3,3′-dimethyl-4,4′-diaminodicyclohexylmethane, commonly known as BMACM or MACM (and denoted B hereinbelow), bis(p-aminocyclohexyl)methane, commonly known as PACM (and denoted P hereinbelow), and bis(aminomethyl)cyclohexane (BAC), in particular 1,3-BAC or, in particular 1,4-BAC.

A nonexhaustive list of these cycloaliphatic diamines is given in the publication “Cycloaliphatic Amines” (Encyclopedia of Chemical Technology, Kirk-Othmer, 4th edition (1992), pp. 386-405).

The aromatic diamine can be chosen from 1,3-xylylenediamine and 1,4-xylylenediamine.

The dicarboxylic acid can be chosen from linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing 36 carbons.

The abovementioned fatty acid dimers are dimerized fatty acids obtained by oligomerization or polymerization of unsaturated monobasic fatty acids having a long hydrocarbon chain (such as linoleic acid and oleic acid), as described in particular in the document EP 0 471566.

When the dicarboxylic acid is cycloaliphatic, it can comprise the following carbon backbones: norbornylmethane, cyclohexane, cyclohexylmethane, dicyclohexylmethane, dicyclohexylpropane, di(methylcyclohexyl) or di(methylcyclohexyl)propane.

When the dicarboxylic acid is aromatic, it is advantageously chosen from terephthalic acid (denoted T), isophthalic acid (denoted I) and 2,6-naphthalenedicarboxylic acid (denoted N) or their mixtures; in particular, it is chosen from terephthalic acid (denoted T), isophthalic acid (denoted I) or their mixtures.

In a fourth alternative form, said polyamide is obtained from a blend of at least two of these three alternative forms.

Advantageously, said polyamide is a semicrystalline polyamide.

In a first embodiment, said polyamide is chosen from a semicrystalline aliphatic polyamide exhibiting a mean number of carbon atoms per nitrogen atom of C₄ to C₁₅ and a semicrystalline semiaromatic polyamide (PPA).

In the case of a homopolyamide of XY type, with X denoting a unit obtained from a diamine and Y denoting a unit obtained from a dicarboxylic acid, the number of carbon atoms per nitrogen atom is the mean of the numbers of carbon atoms present in the unit resulting from the diamine X and in the unit resulting from the diacid Y. Thus, PA6.12 is a PA having 9 carbon atoms per nitrogen atom, in other words a C₉ PA. PA6.13 is a C_{9.5} PA.

In the case of the copolyamides, the number of carbon atoms per nitrogen atom is calculated according to the same principle. The calculation is carried out on a molar pro rata basis from the various amide units.

Said semiaromatic polyamide PPA, optionally modified with urea units, in particular chosen from a PA MXD6, a PA MXD10 or a semiaromatic polyamide of formula X/YAr, as described in EP 1505 099, in particular a semiaromatic polyamide of formula A/ZT in which A is chosen from a unit obtained from an amino acid as defined above, a unit obtained from a lactam as defined above and a unit corresponding to the formula (Ca diamine).(Cb diacid), with a representing the number of carbon atoms of the diamine and the Ca diamine being as defined for the diamine X above and b representing the number of carbon atoms of the diacid and the Cb diacid being as defined for the dicarboxylic acid Y above; ZT denotes a unit obtained from the polycondensation of an aliphatic or cycloaliphatic Cx diamine as defined above for the diamine X and of terephthalic acid.

A/ZT represents in particular a polyamide of formula A/6T, A/9T, A/10T or A/11T, A being as defined above, in particular a polyamide chosen from PA6/6T, PA66/6T, PA6I/6T, PA610/10T, PA612/10T, PA1010/10T, PA1012/10T, PA1212/10T, PA610/12T, PA612/12T, PA1010/12T, PA1012/12T, PA1212/12T, PA11/6T/10T, PA11/10T, PA12/10T, PA11/12T, PA12/12T, PAMPMDT/6T, PAMXDT/10T, PAMPMDT/10T, PABACT/10T, PABACT/6T, PABACT/10T/6T or a PA11/BACT/10T,
especially a polyamide chosen from PA11/10T, PA12/10T, PA11/12T, PA12/12T, PA610/10T, PA612/10T, PA1010/10T, PA1012/10T, PA1212/10T, PA610/12T, PA612/12T, PA1010/12T, PA1012/12T and PA1212/12T, especially PA11/10T and PA11/12T.

T corresponds to terephthalic acid, MXD corresponds to m-xylylenediamine, MPMD corresponds to methylpentamethylenediamine and BAC corresponds to bis(aminomethyl)cyclohexane.

In a first alternative form of this first embodiment, said semicrystalline aliphatic polyamide exhibits a mean number of carbon atoms per nitrogen atom of from C₄ to C₉.

Advantageously, said semicrystalline aliphatic polyamide is chosen from PA6, PA66, PA410, PA412, PA610 and PA612, in particular PA610 and PA612.

Said polyamide of this first alternative form of this first embodiment can be used in the outer layer (II) of said tubular structure of the invention which is present inside the battery pack of said electric vehicle.

Said polyamide of this first alternative form of this first embodiment can also be used in the outer layer (II) of said tubular structure of the invention which is present inside and/or outside the battery pack of the stationary energy storage system.

In a second alternative form of this first embodiment, said semicrystalline aliphatic polyamide exhibits a mean number of carbon atoms per nitrogen atom of from C₁₀ to C₁₅.

Advantageously, said semicrystalline aliphatic polyamide is chosen from PA614, PA618, PA1010, PA1012, PA1014, PA1018, PA1210, PA1212, PA1214, PA1218, PA11 or PA12, in particular PA11 and PA12.

Said polyamide of this second alternative form of this first embodiment can be used in the outer layer (II) of said tubular structure of the invention which is present inside and/or outside the battery pack of said electric vehicle.

Said polyamide of this second alternative form of this first embodiment can also be used in the inner layer (II) of said tubular structure of the invention which is present inside and/or outside the battery pack of the stationary energy storage system.

In a second embodiment, said polyamide is a semicrystalline semiaromatic polyamide (PPA).

Advantageously, said semicrystalline semiaromatic polyamide of this second embodiment is chosen from PA6/6T, PA66/6T, PA6I/6T, PA610/10T, PA612/10T, PA1010/10T, PA1012/10T, PA1212/10T, PA610/12T, PA612/12T, PA1010/12T, PA1012/12T, PA1212/12T, PA11/6T/10T, PA11/10T, PA11/12T, PAMPMDT/6T, PAMXDT/10T, PAMPMDT/10T, PABACT/10T, PABACT/6T, PABACT/10T/6T or PA11/BACT/10T.

More advantageously, said semicrystalline semiaromatic polyamide of this second embodiment is chosen from PA11/10T, PA12/10T, PA11/12T, PA12/12T, PA610/10T, PA612/10T, PA1010/10T, PA1012/10T, PA1212/10T, PA610/12T, PA612/12T, PA1010/12T, 10 PA1012/12T and PA1212/12T, especially PA11/10T and PA11/12T.

Said polyamide of this second embodiment can be used in the outer layer (II) of said tubular structure of the invention which is present inside and/or outside the battery pack of said electric vehicle or the battery pack of the stationary energy storage system.

### Regarding the Thermoplastic Polymer P1:

### The Polyolefin:

According to one embodiment, the layer (I) can comprise at least one polyolefin.

In one embodiment, said polyolefin of the inner layer (I) can be a nonfunctionalized polyolefin chosen from a polyethylene and a polypropylene. It can in particular be a high density polyethylene (HDPE).

According to one embodiment, the inner layer (I) comprises, with respect to the total weight of the layer (I), at least 20% by weight of a polyolefin, optionally from 0% to 80% by weight of an elastomer and optionally from 0% to 5% by weight of a heat stabilizer.

The polyolefin can be functionalized or nonfunctionalized or a blend of these.

To simplify, the polyolefin has been denoted by (B) and functionalized polyolefins (B1) and nonfunctionalized polyolefins (B2) have been described below.

A nonfunctionalized polyolefin (B2) is conventionally a homopolymer or copolymer of α-olefins or of diolefins, such as, for example, ethylene, propylene, 1-butene, 1-octene or butadiene. Mention may be made, by way of examples, of:
polyethylene homopolymers and copolymers, in particular LDPE, HDPE, LLDPE (linear low density polyethylene), VLDPE (very low density polyethylene), PE-Raised Temperature (or PE-RT) and metallocene polyethylene,
propylene homopolymers or copolymers,
ethylene/α-olefin, such as ethylene/propylene, copolymers, EPRs (abbreviation for ethylene-propylene rubber) and ethylene/propylene/diene (EPDM),
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to reach 40% by weight.

The functionalized polyolefin (B1) can be a polymer of α-olefins having reactive units (the functionalities); such reactive units are the acid, anhydride or epoxy functions. By way of example, mention may be made of the preceding polyolefins (B2) grafted or co- or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals, such as Zn, and the like), or also with carboxylic acid anhydrides, such as maleic anhydride. A functionalized polyolefin is, for example, a PE/EPR blend, the ratio by weight of which can vary within broad limits, for example between 40/60 and 90/10, said blend being cografted with an anhydride, in particular maleic anhydride, according to a degree of grafting, for example, of from 0.01% to 5% by weight.

The functionalized polyolefin (B1) can be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/α-olefin, such as ethylene/propylene, copolymers, EPRs (abbreviation for ethylene-propylene rubber) and ethylene/propylene/diene (EPDM);
styrene/ethylene-butene/styrene (SEBS), styrene/butadiene/styrene (SBS), styrene/isoprene/styrene (SIS) or styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) can also be chosen from ethylene/propylene copolymers, predominant in propylene, grafted with maleic anhydride and then condensed with monoaminated polyamide (or a monoaminated polyamide oligomer) (products described in EP-A-0 342 066).

The functionalized polyolefin (B1) can also be a co- or terpolymer of at least the following units: (1) ethylene, (2) alkyl (meth)acrylate or saturated carboxylic acid vinyl ester and (3) anhydride, such as maleic anhydride, or (meth)acrylic acid or epoxy, such as glycidyl (meth)acrylate.

Mention may be made, as examples of functionalized polyolefins of the latter type, of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the copolymers which precede, the (meth)acrylic acid can be salified with Zn or Li.

The term “alkyl (meth)acrylate” in (B1) or (B2) denotes C₁ to C₈ alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) can also be crosslinked by any appropriate process or agent (diepoxy, diacid, peroxide, and the like); the term “functionalized polyolefin” also comprises the mixtures of the abovementioned polyolefins with a difunctional reactant, such as diacid, dianhydride, diepoxy, and the like, which is capable of reacting with these abovementioned polyolefins or the blends of at least two functionalized polyolefins which can react together.

The abovementioned copolymers, (B1) and (B2), can be copolymerized in random or block fashion and can exhibit a linear or branched structure.

The molecular weight, the MFI index and the density of these polyolefins can also vary within a broad range, which will be perceived by a person skilled in the art. MFI is the abbreviation for Melt Flow Index. It is measured according to the standard ASTM 1238.

Advantageously, the nonfunctionalized polyolefins (B2) are chosen from polypropylene homopolymers or copolymers and any homopolymer of ethylene or copolymer of ethylene and of a comonomer of higher α-olefin type, such as butene, hexene, octene or 4-methyl-1-pentene. Mention may be made, for example, of PPs, high density PEs, medium density PEs, linear low density PEs, low density PEs or very low density PEs. These polyethylenes are known by a person skilled in the art as being produced according to a “radical” process, according to a “Ziegler” type catalysis or, more recently, according to a “metallocene” catalysis.

Advantageously, the functionalized polyolefins (B1) are chosen from any polymer comprising α-olefin units and units carrying reactive polar functions, such as epoxy, carboxylic acid or carboxylic acid anhydride functions. Mention may be made, by way of example of such polymers, of terpolymers of ethylene, of alkyl acrylate and of maleic anhydride or of glycidyl methacrylate, such as the Lotader® products (SK Functional Polymer), or polyolefins grafted with maleic anhydride, such as the Orevac® products (SK Functional Polymer), and also terpolymers of ethylene, of alkyl acrylate and of (meth)acrylic acid. Mention may also be made of polypropylene homopolymers or copolymers grafted with a carboxylic acid anhydride and then condensed with monoaminated polyamides or monoaminated polyamide oligomers.

In one embodiment, the polyolefin is crosslinked.

In another embodiment, the polyolefin is a mechanical blend of a thermoplastic olefinic polymer having a polyethylene or polypropylene matrix and of an elastomer, which is vulcanized, such as a vulcanized PP/EPDM blend.

### The Thermoplastic Elastomer:

According to one embodiment, the layer (I) can comprise at least one thermoplastic elastomer.

The thermoplastic elastomer is a block copolymer (ether-amide block copolymer: PEBA), ether-ester block copolymer, a thermoplastic polyurethane: TPU, a thermoplastic styrene elastomer).

Advantageously, said thermoplastic polymer P1 of the inner layer (I) is chosen from nonfunctionalized polyolefins, functionalized polyolefins and a blend of these.

Advantageously, said at least one thermoplastic polymer P1 of the inner layer (I) is a nonfunctionalized polyolefin and said tubular structure then comprises a tie layer (Ill) located between said layer (I) and said layer (II).

In one embodiment, said at least one thermoplastic polymer P1 of the inner layer (I) is a nonfunctionalized polyolefin chosen from a polyethylene and a polypropylene. It can in particular be a high density polyethylene (HDPE).

According to one embodiment, the inner layer (I) comprises, with respect to the total weight of the layer (I), at least 20% by weight of a polyolefin, optionally from 0% to 80% by weight of an elastomer and optionally from 0% to 5% by weight of a heat stabilizer.

The polyolefin can be as defined above.

As regards the elastomer, it can in particular be a TPE (thermoplastic elastomer), that is to say a compound manufactured from a hard thermoplastic material of PP, PBT or PA type, combined with a soft rubbery material.

Mention may in particular be made, as examples of thermoplastic elastomer suitable for the invention, of thermoplastic olefins (TPE-O), SBS, SEBS or SEPS styrene compounds (TPE-S), vulcanized PP/EPDM compounds (TPE-V), copolyester compounds (TPE-E), thermoplastic polyurethanes (TPE-U) and thermoplastic polyamides (TPE-A).

### Regarding the Binder

The binder can be an adhesive composition as described in EP 2 098 580, that is to say an adhesive composition comprising:
at least one polyamide, denoted A, exhibiting a mean number of carbon atoms per nitrogen atom, denoted C_{A}, of between 4 and 8.5, advantageously between 4 and 7;
at least one polyamide, denoted B, exhibiting a melting point of greater than or equal to 180° C. and a mean number of carbon atoms per nitrogen atom, denoted C_{B}, of between 7 and 10, advantageously between 7.5 and 9.5;
at least one polyamide, denoted C, exhibiting a mean number of carbon atoms per nitrogen atom, denoted Cc, of between 9 and 18, advantageously between 10 and 18;
at least 50% by weight of said composition being formed of one or more polyamides chosen from the polyamides A, B and C, the weighted mean by weight of the enthalpies of fusion of these polyamides within said composition being greater than 25 J/g (DSC), the mean number of carbon atoms per nitrogen atom of the polyamides A, B and C additionally corresponding to the following strict inequation: C_{A}<C_{B}<C_{C}.

The binder can also be, for example, but without being limited to these, a composition based on 50% of copolyamide 6/12 (with a ratio of 70/30 by weight) and on 50% of copolyamide 6/12 (with a ratio of 30/70 by weight), a composition based on PP (polypropylene) grafted with maleic anhydride, known under the name of Admer QF551A from Mitsui, a composition based on PA610 and on PA6 and on organic stabilizers, a composition based on PA612 and on PA6 and on organic stabilizers, a composition based on PA610 (of Mn 30 000, and as defined elsewhere) and on PA12 and on organic stabilizers, a composition based on PA6, on PA12 and on functionalized EPR Exxelor VA1801 (Exxon) and on organic stabilizers or also a composition based on PA610, on PA6 and on impact modifier of ethylene/ethyl acrylate/anhydride type in a ratio by weight of 68.5/30/1.5 (MFI 6 at 190° C. under 2.16 kg) and on organic stabilizers.

The binder can also be a functionalized polyolefin (such as polyethylene or polypropylene) copolymer, the functional comonomer of which is chosen from acid, anhydride or epoxide groups.

The functional group is chosen from compounds of carboxylic acids or of their anhydride derivatives of carboxylic acids which are unsaturated.

Examples of unsaturated dicarboxylic acid anhydrides are in particular maleic anhydride, itaconic anhydride, citraconic anhydride or tetrahydrophthalic anhydride. Maleic anhydride is preferably used.

However, the functional comonomer can comprise a function of the unsaturated epoxide type.

Examples of unsaturated epoxides are in particular: aliphatic glycidyl esters and ethers, such as allyl glycidyl ether, glycidyl vinyl ether, glycidyl maleate, glycidyl itaconate, glycidyl acrylate and glycidyl methacrylate (GMA), and alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 2-methyl-5-norbornene-2-carboxylate and diglycidyl endo-cis-bicyclo[2.2.1]hept-5-ene-2,3-dicarboxylate.

### Regarding the Flame Retardant

It is present at from 15% to 38% in the composition of the outer layer (II).

The flame-retarding agent can be a halogen-free flame-retarding agent, such as described in US 2008/0274355, and in particular a phosphorus-based flame-retarding agent.

The flame retardant is in particular a metal salt chosen from a metal salt of phosphinic acid, a metal salt of diphosphinic acid, a polymer containing at least one metal salt of phosphinic acid or a polymer containing at least one metal salt of diphosphinic acid. The flame retardant can also be a mixture of the abovementioned flame retardants.

The flame-retarding agent can also be chosen from the metal salt of phosphinic acid of following formula (I) and the metal salt of diphosphinic acid of following formula (II):

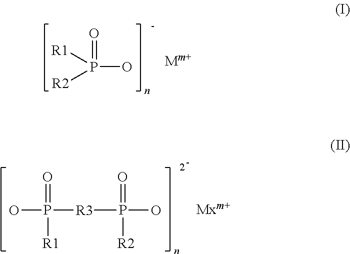

with
R1 and R2, independently of each other, denoting a linear or branched C₁-C₆ alkyl group or an aryl group;
R3 representing a linear or branched C₁-C₁₀ alkylene, C₆-C₁₀ arylene, C₆-C₁₀ alkylarylene or C₆-C₁₀ arylalkylene group,
M being an Mg, Ca, Al, Sb, Sn, Ge, Ti, Zn, Fe, Zr, Ce, Bi, Sr, Mn, Li, Na or K ion and/or a protonated amine base,
m denoting an integer from 1 to 4,
n denoting an integer from 1 to 4,
x denoting an integer from 1 to 4,
n and m being chosen so that the salt is neutral, that is to say that it does not carry an electrical charge.

Preferably, M represents a calcium, magnesium, aluminum or zinc ion.

Preferably, R1 and R2, independently of each other, denote a methyl, ethyl, n-propyl, isopropyl, n-butyl, tert-butyl, n-pentyl and/or phenyl group.

Preferably, R3 is a methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene or phenylbutylene group.

The flame retardant can also be based on phosphonic acid, such as organic phosphonates which are salts with an organic or inorganic cation, or phosphonic acid esters. Preferred phosphonic acid esters are diesters of alkyl- or phenylphosphonic acids. Examples of phosphonic esters to be used as flame retardants according to the invention comprise the phosphonates of general formula (III):

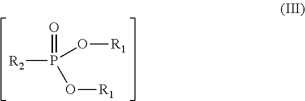

in which:
R1 represents optionally substituted alkyl, cycloalkyl or phenyl groups, where the two R1 radicals can also be bonded to one another in a ring, and
R2 is an optionally substituted alkyl, cycloalkyl or phenyl radical.

The flame retardant can also be melamine or melamine cyanurate.

The flame retardant can also be a mixture of a flame-retarding agent based on aluminum phosphinate and of a flame-retardancy synergistic agent.

The flame-retardancy synergistic agents are in particular as described in WO2005121234.

They can be chosen from nitrogen synergists, phosphorus synergists and phosphorus/nitrogen synergists.

The nitrogen synergists preferably comprise benzoguanamine, tris(hydroxyethyl)isocyanurate, allantoin, glycoluril, melamine, melamine cyanurate, dicyandiamide, guanidine and carbodiimides.

The nitrogen synergists preferably comprise melamine condensation products. By way of example, the condensation products of melamine are melem, melam or melon, or compounds of this type with a higher degree of condensation, or else a mixture of these, and, by way of example, can be prepared by the process described in U.S. Pat. No. 5,985,960.

The phosphorus/nitrogen synergists can comprise reaction products of melamine with phosphoric acid or condensed phosphoric acids, or comprise reaction products of melamine condensation products with phosphoric acid or condensed phosphoric acids, or else comprise a mixture of the specified products.

and flame-retardancy synergists, in particular nitrogen synergists, especially based on melamine.

Regarding the Compound Chosen from a Heat Stabilizer and a Metal Deactivator

The heat stabilizer can be an organic stabilizer or more generally a combination of organic stabilizers, such as a primary antioxidant of phenol type (for example of the type of that of Irganox 245 or 1098 or 1010 from Ciba), a secondary antioxidant of phosphite type and indeed even optionally other stabilizers, such as a HALS, which means Hindered Amine Light Stabilizer (for example Tinuvin 770 from Ciba), a UV absorber (for example Tinuvin 312 from Ciba) or a phenolic or phosphorus-based stabilizer. Use may also be made of antioxidants of amine type, such as Naugard 445 from Crompton, or also polyfunctional stabilizers, such as Nylostab S-EED from Clariant.

The organic stabilizer can be chosen, without this list being restrictive, from:
phenolic antioxidants, for example Irganox 245, Irganox 1010 or Irganox 1098 from Ciba, Irganox MD1024 from Ciba or Lowinox 44B25 from Great Lakes,
phosphorus-based stabilizers, such as phosphites, for example Irgafos 168 from Ciba,
a UV absorber, such as Tinuvin 312 from Ciba,
a HALS, as mentioned above,
a stabilizer of amine type, such as Naugard 445 from Crompton, or also of hindered amine type, such as Tinuvin 770 from Ciba,
a polyfunctional stabilizer, such as Nylostab S-EED from Clariant.

The stabilizer can also be an inorganic stabilizer, such as a copper-based stabilizer.

The copper-based stabilizer can be chosen from cuprous chloride, cupric chloride, cuprous bromide, cupric bromide, cuprous iodide, cupric iodide, cuprous acetate and cupric acetate. Mention may be made of halides or acetates of other metals, such as silver, in combination with the copper-based stabilizer. These copper-based compounds are typically combined with alkali metal halides. A well-known example is the mixture of Cul and Kl, where the Cul:Kl ratio is typically of between 1:5 and 1:15. An example of such a stabilizer is Polyadd P201 from Ciba.

Fuller details with regard to copper-based stabilizers will be found in the patent U.S. Pat. No. 2,705,227. More recently, copper-based stabilizers, such as complexed coppers, for instance Bruggolen H3336, Bruggolen H3337 and Bruggolen H3373 from Bruggemann, have emerged.

Advantageously, the copper-based stabilizer is chosen from copper halides, copper acetate, copper halides or copper acetate as a mixture with at least one alkali metal halide, and their mixtures, preferably the mixtures of copper iodide and of potassium iodide (Cul/Kl).

The metal deactivator used is a conventional deactivator used for polyolefins; for example, hydrazides can be used.

### Regarding the Composition of the Outer Layer (II)

Said composition comprises by weight, with respect to the total weight of said composition:
a) at least 50% of at least one polyamide,
b) from 15% to 38% of at least one flame retardant,
c) from 4% to 20%, in particular from 4% to 15%, of a polyolefin,
d) from 0% to 10%, in particular from 0.1% to 10%, by weight, of at least one plasticizer,
e) from 0% to 5%, in particular from 0.1% to 5%, of at least one additive,
the sum a)+b)+c)+d)+e) being equal to 100%.

In one embodiment, said composition comprises by weight, with respect to the total weight of said composition:
a) at least 50% of at least one polyamide,
b) from 15% to 38% of at least one flame retardant,
c) from 4% to 15% of a polyolefin,
d) from 0% to 10%, in particular from 0.1% to 10%, by weight, of at least one plasticizer,
e) from 0% to 5%, in particular from 0.1% to 5%, of at least one additive,
the sum a)+b)+c)+d)+e) being equal to 100%.

In a first alternative form of this embodiment, said composition comprises by weight, with respect to the total weight of said composition:
a) at least 50% of at least one polyamide,
b) from 15% to 38% of at least one flame retardant,
c) from 4% to 15% of a polyolefin,
d) from 0.1% to 10% by weight of at least one plasticizer,
e) from 0% to 5%, in particular from 0.1% to 5%, of at least one additive,
the sum a)+b)+c)+d)+e) being equal to 100%.

In a second alternative form, said composition comprises by weight, with respect to the total weight of said composition:
a) at least 50% of at least one polyamide,
b) from 15% to 38% of at least one flame retardant,
c) from 4% to 15% of a polyolefin,
d) from 0% to 10%, in particular from 0.1% to 10%, by weight, of at least one plasticizer,
e) from 0.1% to 5% of at least one additive,
the sum a)+b)+c)+d)+e) being equal to 100%.

In a third alternative form, said composition comprises by weight, with respect to the total weight of said composition:
a) at least 50% of at least one polyamide,
b) from 15% to 38% of at least one flame retardant,
c) from 4% to 15% of a polyolefin,
d) from 0.1% to 10% by weight of at least one plasticizer,
e) from 0.1% to 5% of at least one additive,
the sum a)+b)+c)+d)+e) being equal to 100%.

The invention also relates to the compositions consisting by weight of the elements a)+b)+c)+d) described in this embodiment and its three alternative forms.

### Regarding the Plasticizer

The plasticizer can be present at up to 10% by weight, in particular it is present at from 0.1% to 10% by weight, with respect to the total weight of the composition.

The plasticizer can be a plasticizer commonly used in compositions based on polyamide(s).

Advantageously, use is made of a plasticizer which exhibits good thermal stability in order for fumes not to be formed during the stages of blending the various polymers and of transformation of the composition obtained.

In particular, this plasticizer can be chosen from:
benzenesulfonamide derivatives, such as n-butylbenzenesulfonamide (BBSA), the ortho and para isomers of ethyltoluenesulfonamide (ETSA), N-cyclohexyltoluenesulfonamide and N-(2-hydroxypropyl)benzenesulfonamide (HP-BSA),
esters of hydroxybenzoic acids, such as 2-ethylhexyl para-hydroxybenzoate (EHPB) and 2-hexyldecyl para-hydroxybenzoate (HDPB),
esters or ethers of tetrahydrofurfuryl alcohol, such as oligoethyleneoxy-tetrahydrofurfuryl alcohol, and
esters of citric acid or of hydroxymalonic acid, such as oligoethyleneoxy malonate.

A preferred plasticizer is n-butylbenzenesulfonamide (BBSA).

Another more particularly preferred plasticizer is N-(2-hydroxypropyl)benzenesulfonamide (HP-BSA). This is because the latter exhibits the advantage of preventing the formation of deposits at the extrusion screw and/or die (“die drool”) during a stage of transformation by extrusion.

Use may very obviously be made of a mixture of plasticizers.

### Regarding the Additive

The additive can be present at up to 5% by weight, in particular it is present at from 0.1% to 5% by weight, with respect to the total weight of said composition.

The at least one additive can be chosen from stabilizers, dyes, adjuvants assisting in the transformation (processing aids), surfactants, nucleating agents, pigments, brighteners, antioxidants, lubricants, waxes or a mixture of these.

By way of example, the stabilizer can be a UV stabilizer, an organic stabilizer or more generally a combination of organic stabilizers, such as an antioxidant of phenol type (for example of the type of that of Irganox® 245 or 1098 or 1010 from Ciba-BASF), an antioxidant of phosphite type (for example Irgafos® 126 or Irgafos® 168 from Ciba-BASF) and indeed even optionally other stabilizers, such as a HALS, which means Hindered Amine Light Stabilizer (for example Tinuvin® 770 from Ciba-BASF), a UV absorber (for example Tinuvin® 312 from Ciba) or a phosphorus-based stabilizer. Use may also be made of antioxidants of amine type, such as Naugard® 445 from Crompton, or also of polyfunctional stabilizers, such as Nylostab® S-EED from Clariant.

This stabilizer can also be an inorganic stabilizer, such as a copper-based stabilizer. Mention may be made, as examples of such inorganic stabilizers, of copper halides and acetates. Incidentally, other metals, such as silver, can optionally be considered but these are known to be less effective. These copper-based compounds are typically combined with halides of alkali metals, in particular potassium.

In one embodiment, the additives are chosen from antioxidants and colored pigments.

### Regarding the Structure

Said structure comprises at least two layers, an inner layer (I) and an outer layer (II) as defined above.

In one embodiment, said structure consists of the two layers (I) and (II) defined above.

In another embodiment, depending on the formulation of the polyolefin or of the blend of thermoplastic elastomer and of polyolefin, a tie layer as defined above may be necessary to provide the adhesion between the layers (I) and (II).

The structure then comprises the following layers, from the outside toward the inside: (II)//tie//(I).

Whatever the structure, in one embodiment, the thickness of the outer layer represents from 5% to 30% of the total thickness of said structure.

In another embodiment, the thickness of the inner layer represents at least 70% of the total thickness, in particular from 70% to 95% of the total thickness.

In yet another embodiment, the thickness of the outer layer represents from 5% to 30% of the total thickness of said structure and the inner layer represents at least 70% of the total thickness, in particular from 70% to 95% of the total thickness.

Advantageously, said at least one thermoplastic polymer P1 of the inner layer (I) is chosen from nonfunctionalized polyolefins, functionalized polyolefins and a blend of these.

In one embodiment, said at least one thermoplastic polymer P1 of the inner layer (I) is a nonfunctionalized polyolefin chosen from a polyethylene and a polypropylene.

In another embodiment, said at least one thermoplastic polymer P1 of the inner layer (I) is a nonfunctionalized polyolefin which is a polyethylene.

In yet another embodiment, said at least one thermoplastic polymer P1 of the inner layer (I) is a nonfunctionalized polyolefin which is a polypropylene.

In a first alternative form, whether the structure comprises two or three layers, said structure comprises a layer (II) which comprises a composition based on a semicrystalline aliphatic polyamide exhibiting a mean number of carbon atoms per nitrogen atom of C₄ to C₁₅.

In one embodiment of this first alternative form, the layer (I) of said structure is made of polypropylene, in particular stabilized by a compound chosen from a heat stabilizer and a metal deactivator or a mixture of these.

In a second alternative form, whether the structure comprises two or three layers, said structure comprises a layer (II) which comprises a composition based on a semicrystalline aliphatic polyamide exhibiting a mean number of carbon atoms per nitrogen atom of C₄ to C₉, the layer (I) of said structure is made of polypropylene, in particular stabilized by a compound chosen from a heat stabilizer and a metal deactivator or a mixture of these.

Advantageously, in this second alternative form, said polyamide is chosen from PA6, PA66, PA410, PA412, PA610 and PA612, in particular PA610 and PA612.

In this second alternative form, said structure is present inside the battery pack of said electric vehicle.

In this second alternative form, said structure can also be present inside and/or outside the battery pack of the stationary energy storage system.

In a third alternative form, whether the structure comprises two or three layers, said structure comprises a layer (II) which comprises a composition based on a semicrystalline aliphatic polyamide exhibiting a mean number of carbon atoms per nitrogen atom of C₁₀ to C₁₅, the layer (I) of said structure is made of polypropylene, in particular stabilized by a compound chosen from a heat stabilizer and a metal deactivator or a mixture of these.

Advantageously, in this third alternative form, said polyamide is chosen from PA614, PA618, PA1010, PA1012, PA1014, PA1018, PA1210, PA1212, PA1214, PA1218, PA11 or PA12, in particular PA11 and PA12.

In this third alternative form, said structure is present inside and/or outside the battery pack of said electric vehicle.

In this third alternative form, said structure can also be present inside and/or outside the battery pack of the stationary energy storage system.

Advantageously, in all the embodiments of the structure and the various alternative forms, the polyolefin of the inner layer and of the outer layer is identical.

Advantageously, in all the embodiments of the structure and the various alternative forms, the polyolefin of the inner layer and of the outer layer is different.

According to another aspect, the present invention relates to the use of a flame-retardant tubular structure as defined above for the cooling of electric vehicle batteries or of stationary energy storage system batteries.

All the embodiments described above for the polyamide, the polyolefin, the flame retardant and the structure are valid for this use.

The present invention will now be illustrated by nonlimiting examples of the scope of the invention.

### EXAMPLES

The compositions of table 1 were prepared by melt blending polyamide granules with the flame retardants, the polyolefins and optionally the plasticizers and the additives. The % values shown are percentages by weight, with respect to the total weight of the composition. This blending was carried out by compounding on a corotating twin-screw extruder with a 10 diameter of 40 mm with a flat temperature profile (T°) at 250° C. The screw speed is 225 rpm and the throughput is 55 kg/h.

The polyamide(s), the polyolefins and optionally the plasticizers and the additives are introduced during the compounding process via the main hopper. The flame retardant is added to the molten polymer, in the middle of the screw via a side feeder. If a plasticizer is present, it is also introduced into the molten polymer via a pump.

The compositions were subsequently extruded in the form of an 8×1 mm tube by coextrusion.

MLT (8×1 mm multilayer tube) or monolayer (8×1 mm monolayer tube) tubes are manufactured on a conventional multilayer tube extrusion line as described in EP 2 098 580 or on a conventional Maillefer 60 monolayer line when monolayers are concerned in order to study the mechanical properties and the fire resistance according to the standards below.

The temperature profile used for non-flame-retardant and flame-retardant PAs is as follows (from the feed zone of the granules up to the end of the screw): 210/220/220/220. The temperature (melt) at the die outlet is of the order of 220° C. The polyolefins are extruded with the following temperature profile: 160/210/220/220. The temperature of the melt at the die outlet is of the order of 220° C. The mandrel has an external diameter of 12 mm and the die has an internal diameter of 18 mm. The tubes are obtained with bores, the internal diameter of which is between 8.5 mm and 9.2 mm.

The monolayer and multilayer tubes produced by extrusion above were subsequently evaluated with regard to several criteria:
flexibility;
VW−40° C. impact;
cooling type mixed aging. The tube is filled with an aqueous glycol solution (Havoline solution (50% by weight) diluted in water) and aged thermally in an oven at 110° C.

The results and methods of measurement are given in the following tables 2 to 4.

The structures of the invention and comparative structures were tested with a test usually carried out of flame propagation, referred to as UL94 according to the standard (IEC 60695-11-10), on the external part of the tube.

The UL94 test, generally applied to a bar of a single product, is carried out here on a monolayer structure (monolayer tube) or multilayer structure, in particular a three-layer tube, with the flame which is brought into contact solely with the outer layer of the tube, said three-layer tube exhibiting the following layer dimensions: from the outer layer to the inner layer: 0.15 mm//0.10 mm//0.75 mm or 0.350 mm//0.10 mm//0.55 mm.

TABLE 1

| Example of the | | | | | | |
|---|---|---|---|---|---|---|
| invention (E) or | | | | | | |
| comparative | | | | | | |
| example (CE) | CE1 | CE2 | CE3 | CE4 | E1 | E2 |
| PA11 | 85% by | 75% by | — | 45% by | 57% by | — |
| | weight | weight | | weight | weight | |
| PA610 | — | — | 85% by | — | — | 57% by |
| | | | weight | | | weight |
| Polyolefin | 10% by | 10% by | 10% by | 10% by | 10% by | 10% by |
| Orevac IM | weight | weight | weight | weight | weight | weight |
| 800 | | | | | | |
| Exolit ® | — | 10% by | — | 40% by | 28% by | 28% by |
| OP1311 | | weight | | weight | weight | weight |
| BBSA | 5% by | 5% by | 5% by | 5% by | 5% by | 5% by |
| | weight | weight | weight | weight | weight | weight |

TABLE 2

| | Mono- | Mono- | Mono- | Mono- | Mono- | Mono- | Mono- |
|---|---|---|---|---|---|---|---|
| | layer | layer | layer | layer | layer | layer | layer |
| | CE1 | CE2 | CE3 | CE4 | E1 | E2 | HDPE* |
| Thermal | A | B | A | C | C | C | A |
| aging | | | | | | | |
| aqueous | | | | | | | |
| glycol | | | | | | | |
| solution/air | | | | | | | |
| (5) | | | | | | | |
| Impact at - | 0% | 30% | 0% | 100% | 100% | 100% | 0% |
| 40° C. (3) | | | | | | | |
| Flexibility (2) | 460 | 540 | 490 | 950 | 625 | 657 | 550 |
| Classification | UC | V-2 | UC | V-0 | V-0 | V- | UC |
| UL 94 (5) | | | | | | 0this | |

UC = Unclassified worse than V-2

TABLE 3

| | Triple layer | Triple layer | | | |
|---|---|---|---|---|---|
| | 15% by weight | 15% by weight | | | |
| | E1//10% by | E2//10% by | | Triple layer | Triple layer |
| | weight maleic | weight maleic | Double layer | 15% by weight | 15% by weight |
| | anhydride- | anhydride- | 15% by weight | CE1//10% by | CE3//10% by |
| | grafted LDPE | grafted LDPE | E1//85% by | weight maleic | weight maleic |
| | binder//75% by | binder//75% by | weight HDPE-g- | anhydride- | anhydride- |
| | weight HDPE* | weight HDPE* | MAH** | grafted LDPE | grafted LDPE |
| | In accordance | In accordance | In accordance | binder//75% by | binder//75% by |
| | with the | with the | with the | weight HDPE* | weight HDPE* |
| | invention | invention | invention | Comparative | Comparative |
| Thermal aging | A | A | A | A | A |
| aqueous glycol | | | | | |
| solution/air (4) | | | | | |
| Impact at −40° C. | 0% | 0% | 0% | 0% | 0% |
| (3) | | | | | |
| Flexibility (2) | 567 | 570 | 558 | 536 | 545 |
| Classification | V-0 | V-0 | V-0 | UC | UC |
| UL 94 (5) | | | | | |

TABLE 4

| | Triple layer | Triple layer | Triple layer |
|---|---|---|---|
| | 15% CE4//10% | 15% CE2//10% | 35% CE2//10% |
| | maleic | maleic | maleic |
| | anhydride- | anhydride- | anhydride- |
| | grafted LDPE | grafted LDPE | grafted LDPE |
| | binder//75% | binder//75% | binder//55% |
| | HDPE* | HDPE | HDPE |
| | Comparative | Comparative | Comparative |
| Thermal aging | A | A | A |
| aqueous glycol | | | |
| solution/air (4) | | | |
| Impact at −40° C. | 100% | 0% | 5% |
| (3) | | | |
| Flexibility (2) | 617 | 547 | 552 |
| Classification | V-0 | UC | UC |
| UL 94 (5) | | | |

(1) 8×1 mm monolayer and 8×1 mm multilayer tube, the layers of the triple layers are distributed from the outer layer toward the inner layer as follows: 0.15 mm//0.10 mm//0.75 mm and 0.35 mm//0.10 mm//0.55 mm. The double layer tube is distributed from the outer layer toward the inner layer: 0.15 mm//0.85 mm.
(2) Flexural modulus according to ISO 178:2010 determined at 23° C. with a relative humidity: RH 50% expressed in MPa.
(3) Impact at −40° C. according to the standard VW TL-52435 § 6.5, PV 3905, as % breakage. (4) Resistance to aging at 110° C. in air, half-life in h (corresponds to the point where a 50% reduction in the elongation is obtained, according to ISO 527-1A.

The aging is sufficiently representative of the aging in air (outside the tube)/fluid (inside the tube) application
A=half-life >1500 h; B=half-life>500 h and <1500 h; C=half-life<500 h.
(5) UL94 evaluation according to IEC 60695-11-10
Orevac® IM 800: Maleic anhydride-modified HDPE (SK Functional Polymer)
Maleic anhydride-grafted LDPE binder: Admer GT7 (Mitsui)
HDPE*: Lupolen GX5038 (LyondellBasell)
HDPE-g-MAH**: blend of 93% by weight of Lupolen GX5038 (LyondellBasell) and of 7% by weight of Orevac OE25 (SK Functional Polymer) as a dry blend. The addition of Orevac OE25, LLDPE highly grafted with maleic anhydride, makes it possible to have an HDPE-g-MAH for adhering to a polyamide layer.

1. A flame-retardant multilayer tubular structure for the cooling of electric vehicle batteries or of stationary energy storage system batteries comprising at least two layers:
an inner layer (I) comprising at least 40% of at least one thermoplastic polymer P1 chosen from a polyolefin and a thermoplastic elastomer and up to 5% by weight of a compound chosen from a heat stabilizer and a metal deactivator or a mixture of these, a composition based on a polyolefin, said composition comprising, by weight:
an outer layer (II) comprising a composition based on at least one predominant polyamide, said composition comprising, by weight, with respect to the total weight of the layer (II):
a) at least 50% by weight of at least one polyamide,
b) from 15% to 38% by weight of at least one flame retardant,
c) from 4% to 20% by weight of a polyolefin,
d) from 0% to 10% by weight of at least one plasticizer,
e) from 0% to 5% by weight of at least one additive, the sum a)+b)+c)+d)+e) being equal to 100%.

2. The flame-retardant multilayer tubular structure as claimed in claim 1, wherein the polyamide is chosen from a semicrystalline aliphatic polyamide exhibiting a mean number of carbon atoms per nitrogen atom of from 4 to 15 and a semicrystalline semiaromatic polyamide (PPA).

3. The flame-retardant multilayer tubular structure as claimed in claim 2, wherein the semicrystalline aliphatic polyamide exhibits a mean number of carbon atoms per nitrogen atom of from 4 to 9.

4. The flame-retardant multilayer tubular structure as claimed in claim 3, wherein the semicrystalline aliphatic polyamide is chosen from PA6, PA66, PA410, PA412, PA610 and PA612.

5. The flame-retardant multilayer tubular structure as claimed in claim 3, wherein the structure is present inside the battery pack of said electric vehicle.

6. The flame-retardant multilayer tubular structure as claimed in claim 2, wherein the semicrystalline aliphatic polyamide exhibits a mean number of carbon atoms per nitrogen atom of from 10 to 15.

7. The flame-retardant multilayer tubular structure as claimed in claim 6, wherein the semicrystalline aliphatic polyamide is chosen from PA614, PA618, PA1010, PA1012, PA1014, PA1018, PA1210, PA212, PA1214, PA1218, PA11 and PA12.

8. The flame-retardant multilayer tubular structure as claimed in claim 6, wherein the structure is present inside and/or outside the battery pack of said electric vehicle.

9. The flame-retardant multilayer tubular structure as claimed in claim 3, wherein the structure is present inside and/or outside the battery pack of the stationary energy storage system.

10. The flame-retardant multilayer tubular structure as claimed in claim 2, wherein the polyamide is a semicrystalline semiaromatic polyamide (PPA).

11. The flame-retardant multilayer tubular structure as claimed in claim 10, wherein the semicrystalline semiaromatic polyamide is chosen from PA11/10T, PA12/10T, PA11/12T, PA12/12T, PA610/10T, PA612/10T, PA1010/10T, PA1012/10T, PA1212/10T, PA610/12T, PA612/12T, PA1010/12T, PA1012/12T and PA1212/12T.

12. The flame-retardant multilayer tubular structure as claimed in claim 10, wherein the structure is present inside and/or outside the battery pack of said electric vehicle or the battery pack of the stationary energy storage system.

13. The flame-retardant multilayer tubular structure as claimed in claim 1, wherein said polyolefin P1 of the inner layer (I) is chosen from nonfunctionalized polyolefins, functionalized polyolefins and a blend of these.

14. The flame-retardant multilayer tubular structure as claimed in claim 13, wherein said polyolefin P1 of the inner layer (I) is a nonfunctionalized polyolefin and said tubular structure comprises a tie layer (Ill) located between said layer (I) and said layer (11).

15. The flame-retardant multilayer tubular structure as claimed in claim 1, characterized in that said polyolefin P1 of the inner layer (I) is a nonfunctionalized polyolefin chosen from a polyethylene and a polypropylene.

16. The flame-retardant multilayer tubular structure as claimed in claim 1, characterized in that the outer layer (II) exhibits a thickness of from 5% to 30% of the total thickness of said structure.

17. The flame-retardant multilayer tubular structure as claimed in claim 1, wherein the inner layer (I) exhibits a thickness of at least 70% of the total thickness of said structure.

18. The flame-retardant multilayer tubular structure as claimed in claim 14, wherein the outer layer (II) exhibits a thickness of from 5% to 30% of the total thickness of said structure and the inner layer (I) exhibits a thickness of at least 70% of the total thickness of said structure.

19. The use of a flame-retardant tubular structure as defined in claim 1, for the cooling of electric vehicle batteries or of stationary energy storage system batteries.
